(19) United States
(12) Patent Application Publication
(10) Pub. No.: US 2010/0150638 A1
(43) Pub. Date: Jun. 17, 2010

(54) Knock-type writing instrument having a shock-relaxing device

(75) Inventors: Yoshiharu Namiki, Kanagawa (JP); Hisami Tamano, Kanagawa (JP)

Correspondence Address: FOLEY AND LARDNER LLP;SUITE 500, 3000 K STREET NW, WASHINGTON, DC, 20007, US

(73) Assignee: MISTSUBISHI PENCIL COMPANY LIMITED, SHINAGAWA-KU (JP)

(21) Appl. No.: 12/733,264

(22) PCT Filed: Aug. 11, 2008
(86) PCT No.: PCT/JP2008/064660

§ 371 Date: Feb. 19, 2010

(30) Foreign Application Priority Data
Aug. 20, 2007 (JP) 2007-213767

(51) Int. Cl. B43K 24/02

(52) U.S. Cl. 401/99

(57) ABSTRACT

Upon depressing a knock rod in a state of writing of FIG. 8A, a cam protuberance 3b of a rotor turns rightward to assume a position shown in FIG. 8B. Upon removing a finger, the cam protuberance 3b turns sliding on a tilted surface, arrives at a position shown in FIG. 8C through a first vertical motion (distance d) and, further, arrives at a position shown in FIG. 8D through a second vertical motion (distance e). Here, a tilted surface of cam protuberance 3b comes in collision with a tilted surface of an inner cylinder cam 2b twice, and shocks are transmitted to a refill 7. By forming a step between the front half and the rear half of the tilted surface of the inner cylinder cam 2b, however, a distance of vertical motion of the cam protuberance 3b each time is shortened to decrease the shock of collision imparted to the refill each time.

### TECHNICAL FIELD

This invention relates to a knock-type writing instrument and, particularly, to a knock-type writing instrument having a mechanism for relaxing shocks imparted to a refill when a knock is released and a safety is released.

### BACKGROUND ART

A safety mechanism stands for a mechanism which when a tip of the clip is lifted up in a state where the pen point of the refill is at the writing position protruding beyond the end of the holder, the pen point draws back into the holding position in the holder. By this mechanism, clothing will not be stained in case the writing instrument is inserted in, for example, a chest pocket of a clothing with the pen point staying out at fault.

Several types of knock-type writing instruments are known. One of them is a Kahn knock-type writing instrument in which if a knocking operation is carried out with the pen point in the writing position and the knock rod is released (hereinafter referred to as “return operation”), a rotor is pushed back by the force of a spring, and a cam protuberance 3b′ of the rotor moves vertically along an inner cylinder cam 2b′ (over a distance a, in the axial direction only) to place the pen in a pen point-holding position (see FIG. 11).

However, due to the above vertical motion of when the knock is released (return operation), a shock is imparted to a refill (ink container). When the refill contains an aqueous ink or a gel ink, in particular, the ink in the refill can be displaced or leak out, whereby air may become trapped in the end of the refill which can result in blurred writing. Therefore, it has been desired to devise a mechanism to reduce the shock caused by the vertical motion.

With a Kahn knock-type writing instrument equipped with a safety function, the writing position is maintained as the tip of the clip is engaged to limit the motion of the rotor. In the return operation, the cam protuberance 3b′ of the rotor vertically moves along the inner cylinder cam 2b′ (by a distance a, in the axial direction only) to establish the pen point-holding position, like an ordinary Kahn knock-type instrument. Here, if the safety release operation is effected (hereinafter referred to as “safety operation”) by lifting up the tip of the clip, however, the motion of the rotor is no longer limited, and the cam protuberance of the rotor vertically moves up to the pen point-holding position. In the case of a cam constitution shown in FIG. 12, for instance, a cam protuberance 3b′ vertically moves (distance i) together with a slide body 6a′.

A shock is imparted to the refill (ink container) even by the collision of when the cam protuberance vertically moves during the safety operation giving rise to the occurrence of the problem described above. Therefore, it has been desired to provide a mechanism for relaxing shocks in the vertical motion.

Japanese Unexamined Patent Publication JP-A-2000-218989, on the other hand, discloses a knock-type writing instrument with safety using a spring as a buffer member.

This system, however, is accompanied by a problem of an increase in the number of parts. The aqueous ink and the gel ink have recently been frequently used, and it has been desired to solve the above inconveniences caused by shocks relying on simple systems.

### DISCLOSURE OF THE INVENTION

An object of this invention is to solve the above problems and to provide a knock-type writing instrument capable of relaxing shocks without increasing the number of parts by contriving the shapes of the cams irrespective of if the writing instrument does not have a safety mechanism or has a safety mechanism.

According to the present invention, there is provided a knock-type writing instrument comprising a refill having a writing portion at a front end thereof, a spring for urging the refill backward, and a knock rod that is arranged at the back of the refill and is linked to the refill and protrudes beyond the rear end of a holder, wherein upon depressing the knock rod, the refill is brought to a writing position protruding beyond the front end of the holder; and wherein a rotor is provided between the knock rod and the refill to support the refill, the knock rod and the rotor have tilted cam surfaces for rotation corresponding to each other, and the rotor rotates in only one direction by only a predetermined angle each time due to the reactive force of the spring and responsive to the knocking operation forward and backward in the axial direction; when the knocking operation is effected in a state where the refill has been drawn back into the holder, a tilted cam surface for positioning formed on the side surface of a cylindrical portion of the rotor comes in contact with a first tilted surface of the cam formed in an inner cylinder corresponding thereto, a vertical surface of the cam for positioning of the rotor comes in contact with a vertical wall of a cam formed in the inner cylinder and maintains the refill at the writing position being supported by the load in the axial direction and by the rotational force; when the knocking operation is effected in a state where the refill is at the writing position, the tilted cam surface for positioning of the rotor comes in contact with a second tilted surface of the cam formed in the inner cylinder continuing to the vertical wall of the cam and, further, rotates upon coming in contact with a third tilted surface of the cam formed in the inner cylinder, and moves to a retreated limit position to maintain the refill at the holding position; wherein the third tilted surface of the cam formed in the inner cylinder has a step in the axial direction.

According to the present invention, there is further provided a knock-type writing instrument comprising a refill having a writing portion at a front end thereof, a spring for urging the refill backward, and a knock rod that is arranged at the back of the refill and is linked to the refill and protrudes beyond the rear end of a holder, wherein upon depressing the knock rod, the refill is brought to a writing position protruding beyond the front end of the holder and an engaging nub of a clip is engaged with an engaging protuberance of a slide body to maintain the writing position; and wherein a rotor is provided between the knock rod and the refill to support the refill, the knock rod and the rotor have tilted cam surfaces for rotation corresponding to each other, and the rotor rotates in only one direction by a predetermined angle each time due to the reactive force of the spring, and responsive to the forward and backward knocking operation in the axial direction; when the knocking operation is effected in a state where the refill has been drawn back into the holder, a tilted cam surface formed on the side surface of a cylindrical portion of the rotor comes in contact with a first tilted surface of the cam formed in an inner cylinder corresponding thereto and with a tilted cam surface formed on the slide body by rotation, a vertical surface of the cam for positioning of the rotor comes in contact with a vertical wall of a cam formed in the holder and maintains the refill at a writing position being supported by the load in the axial direction and by the rotational force; when the knocking operation is effected in a state where the refill is at the writing position, the tilted cam surface for positioning of the rotor comes in contact with a tilted cam surface formed in the holder, and further, rotates upon coming in contact with a second tilted surface of the cam formed in the inner cylinder, and moves to a retreated position to maintain the refill at the holding position; the slide body that can move in the lengthwise direction has an inward protuberance in a cut-away portion of the holder and when the refill is at the writing position, the inward protuberance is brought into engagement with a rear end of the cam for positioning of the rotor, and an engaging protuberance formed on the slide body engages with an engaging step formed in a clip body to maintain the refill at the writing position; when the engagement is released between the engaging protuberance of the slide body and the engaging step of the clip body, the refill is returned by the spring back to the retreated position together with the slide body, and the positioning cam of the rotor moves to the retreated position passing through a gap formed at the back of the tilted cam surface of the holder to maintain the refill at the holding position; wherein the second tilted surface of the cam formed in the inner cylinder has a step in the axial direction.

### BRIEF DESCRIPTION OF THE DRAWINGS

FIG. 1A is a sectional view of a knock-type writing instrument according to second and third embodiments, and shows a state where a refill is at the holding position;

FIG. 1B is a sectional view of the knock-type writing instrument according to the second and third embodiments, and shows a state where the refill is at the writing position;

FIG. 1C is a sectional view of the knock-type writing instrument according to the second and third embodiments, and shows a state where the refill is at the holding position after the safety operation;

FIG. 2 is a sectional view of a clip in FIG. 1;

FIG. 3A is a sectional view along the A-A section of FIG. 1;

FIG. 3B is a sectional view along the B-B section of FIG. 1;

FIG. 4 is a perspective view of a knock rod in FIG. 1;

FIG. 5 is a perspective view of a rotor in FIG. 1;

FIG. 6 is a perspective view of a slide body in FIG. 1;

FIGS. 7A to 7E are schematic views illustrating the motions of a cam protuberance according to a first embodiment;

FIGS. 8A to 8E are schematic views illustrating the motions of the cam protuberance in the return operation according to the second embodiment;

FIGS. 9A to 9E are schematic views illustrating the motions of the cam protuberance in the safety operation according to the second embodiment;

FIGS. 10A to 10D are schematic views illustrating the motions of the cam protuberance according to the third embodiment;

FIGS. 11A to 11D are schematic views illustrating the motions of the cam protuberance according to a conventional system; and

FIGS. 12A to 12D are schematic views illustrating the motions of the cam protuberance in a trial cam arrangement.

### BEST MODE FOR CARRYING OUT THE INVENTION

The embodiments of the invention will now be concretely described based on the drawings. First, the basic construction and operation will be described and next, the characteristic parts of the embodiments will be described.

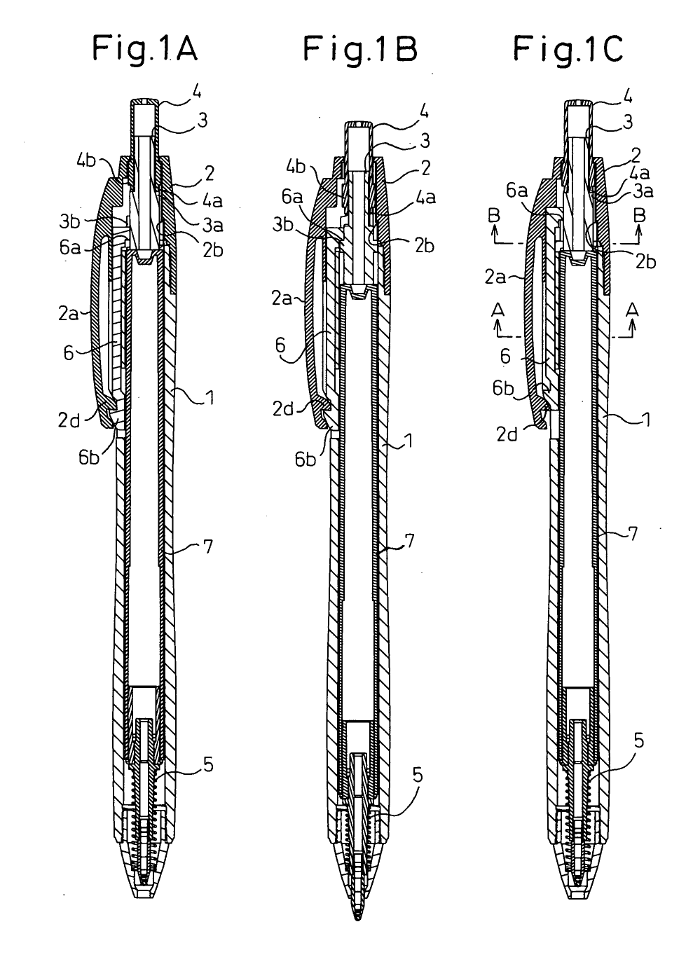

A first embodiment does not have a safety mechanism, and therefore is not equipped with a slide body 6 of FIGS. 1A and 1B. Therefore, this portion is occupied by a holder 1.

Referring to FIGS. 1A and 1B (the safety mechanism is not shown), the first embodiment includes a refill 7 having a writing portion at an end thereof, a spring 5 for urging the refill backward, and a nock rod 4 that is linked to the refill 7 and protrudes beyond the holder 1. Upon depressing the knock rod 4, the refill 7 is brought to a writing position protruding beyond the front part of the holder 1.

A rotor 3 is provided between the knock rod 4 and the refill 7 in front thereof to support the refill 7. The knock rod 4 and the rotor 3 have a knock rod cam 4a and a knock cam 3a forming tilted cam surfaces corresponding to each other, and the rotor 3 rotates in only one direction by only a predetermined angle each time responsive to the forward knocking operation in the axial direction.

Further, when no longer depressed after the knocking operation, the refill 7 is urged backward by the spring 5 and rotates in the same direction as the direction in which the knock rod 4 and the rotor 3 rotate due to a cam protuberance 3b of the rotor 3 and a corresponding cam 2b of an inner cylinder 2. That is, the rotor 3 rotates by a predetermined angle, and rotates once at a given timing (after two times of knocking in this embodiment) to repeat the operation.

The constituent parts will be described below in detail.

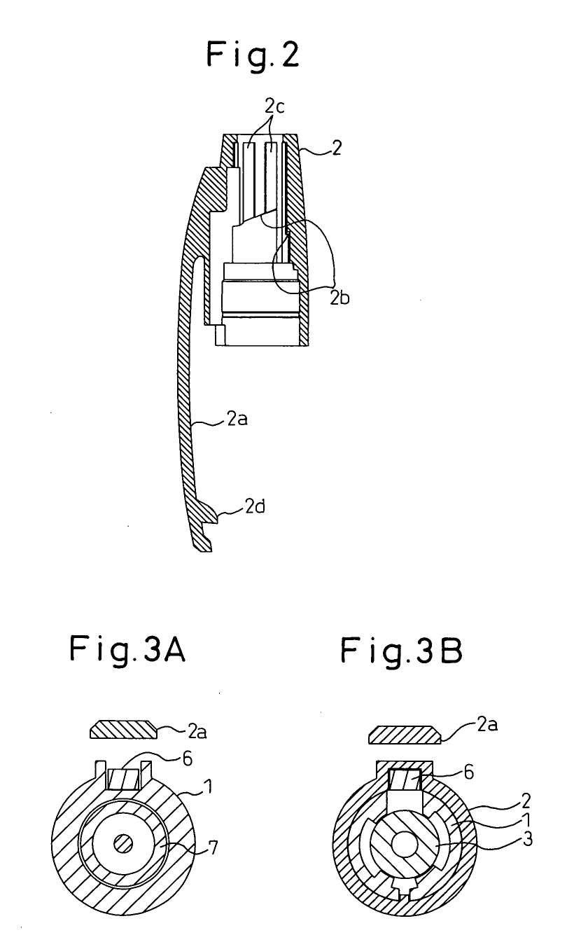

The inner cylinder 2 shown in FIGS. 1A, 1B and 2 is constituted integrally with a clip 2a. On the inner wall surface of the inner cylinder, there are arranged grooves 2c for stopping the turn of the knock rod 4 and an inner cylinder cam 2b for positioning the refill 7. The shape of the inner cylinder cam 2b will be described later in detail.

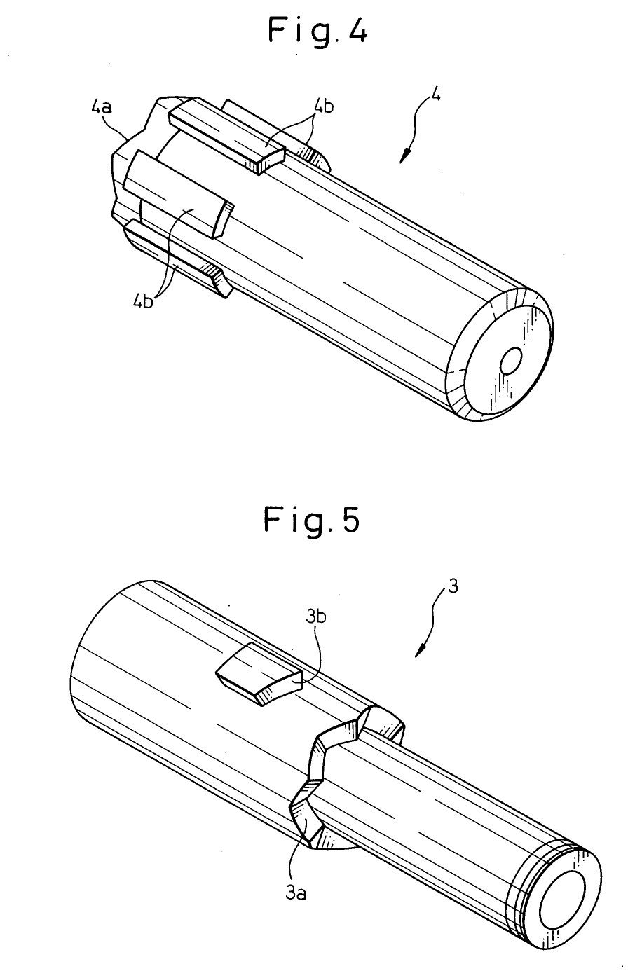

The knock rod 4 shown in FIGS. 1A, 1B and 4 is a cylindrical member disposed at the tail end of the writing instrument, and has a knock rod cam 4a at an end portion thereof and turn stops 4b arranged on the outer circumferential portion near the end thereof to slide in the grooves 2c.

The rotor 3 shown in FIGS. 1A, 1B and 5 is a cylindrical member having a knock cam 3a that comes in contact with the knock rod cam 4a of the knock rod 4 and a cam protuberance 3b for positioning the refill 7.

A spring 5 is arranged in an end of the holder 1 to urge the refill 7 toward the knock rod 4.

The knock rod cam 4a and the knock cam 3a have mountain-shaped tilted cam surfaces corresponding to each other, and are arranged with their mountain-shaped pitches being deviated, whereby the rotor 3 receives a rotational force in a predetermined direction responsive to the knocking operation in the axial direction. Therefore, the rotor 3 rotates in a predetermined direction responsive to each knocking operation accompanied by the operation of the cam protuberance 3b that will be described later.

Further, the end portion of the rotor 3 is in contact with the rear end portion of the refill 7 at all times, and the front and rear positions of the cam protuberance 3b determine the pen point position at the end of the refill 7.

Next, the action of the thus constituted knock-type writing instrument will be described.

The knocking operation is an operation of depressing the knock rod 4 until it is released therefrom, and i.e., a case where the pen point is moved from the retreated state to the writing position. On the other hand, the knock release is an operation of similarly depressing the knock rod 4 until it is released, i.e., a case where the pen point is moved from the writing position to the holding position.

Upon knock-operating the knock rod 4, the rotor 3 and the refill 7 move forward being pushed by the knock rod. As described above, the rotor 3 is imparted with a rotational force (due to a relationship between the knock rod cam 4a and the knock cam 3a) but is restricted from rotating by a vertical wall of the inner cylinder cam 2b. If the cam protuberance 3b of the rotor 3 moves forward to a position beyond the vertical wall of the inner cylinder cam 2b, there is no restriction and the rotor 3 slightly rotates.

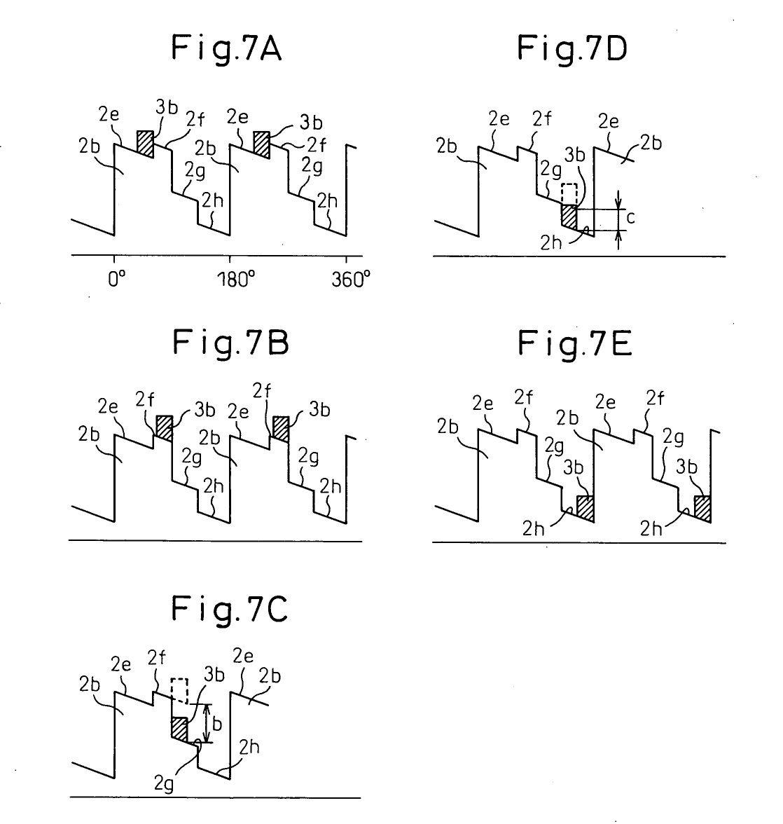

When rod 4 is released, the cam protuberance 3b of the rotor 3 undergoes a rotational motion along the inner cylinder cam 2b. In the ordinary Kahn knock type writing instrument, the inner cylinder cam 2b has been cut so that the rotation stops at the writing position upon hitting the vertical wall of the inner cylinder cam 2b. At a moment when the rotation stops, the pen point at the end of the refill 7 assumes the writing position shown in FIG. 7A.

Next, described below with reference to FIGS. 7A to 7E are the constitution of the inner cylinder cam 2b which is a characteristic part of the embodiment and the operation of the cam protuberance 3b of the rotor 3 which undergoes the rotational motion and the vertical motion while in contact with the inner cylinder cam 2b in the return operation after the knock is released.

The drawings show the positions of the cam protuberance 3b of the rotor 3 with respect to development of the inner cylinder cam 2b formed on the inner surface of the inner cylinder 2. The upper side in the drawings is the direction of the pen point. The cam protuberance 3b of the rotor 3 is imparted with the rotational force due to the cam mechanism of the knock rod 4 and the rotor 3, and therefore moves from the left toward the right in the drawing every knocking operation.

FIGS. 7A to 7E show the motions of the cam protuberance 3b of the rotor 3 in the return operation. FIG. 7A shows a state where the pen point is protruded to assume the state of writing, and the cam protuberance 3b is fixed being pushed onto a first tilted surface 2e and onto the vertical wall of the inner cylinder cam 2b by the reactive force of the spring 5.

If the knock rod 4 is depressed in this state, the cam protuberance 3b moves upward in the drawing and reaches a position beyond the vertical wall of the inner cylinder cam 2b. Thereafter, the cam protuberance 3b is no longer restricted by the vertical wall of the inner cylinder cam 2b, and rotates toward the right and is pushed onto a second tilted surface 2f of the inner cylinder cam 2b as shown in FIG. 7B due to the reactive force of the spring 5 and the action of the tilted cam surface for rotation.

When pressure is released, the cam protuberance 3b, further, rotates and reaches a position shown in FIG. 7C passing through a first vertical motion. At this moment, the tilted surface of the cam protuberance 3b comes into collision with a front half portion 2b of a third tilted surface (hereinafter referred to as “front half tilted surface”) of the inner cylinder cam 2b, and a shock is transmitted to the refill 7.

Further, the cam protuberance 3b rotates sliding on the front half tilted surface 2g of the inner cylinder cam 2b and reaches a position shown in FIG. 7D passing through a second vertical motion. At this moment, the tilted surface of the cam protuberance 3b comes into collision again with a rear half portion 2h of the third tilted surface (hereinafter referred to as “rear half tilted surface”) of the inner cylinder cam 2b, and a shock is transmitted to the refill 7.

Thereafter, the cam protuberance 3b rotates sliding on the rear half tilted surface 2h of the inner cylinder cam 2b, and halts coming in contact with the vertical wall of the inner cylinder cam 2b and arrives at a pen point-holding position shown in FIG. 7E.

Previously, the above collision has occurred only once, and the distance of the vertical motion of prior art was nearly equal to the sum of distances of vertical motions at the two portions in the above constitution of the present invention. By providing a step in the axial direction between the front half and the rear half of the third tilted surface of the inner cylinder cam 2b as described above, the distance of each vertical motion of the cam protuberance 3b can be shortened.

Table 1 shows the distances b, c of vertical motions at two portions in the above constitution and the degrees of shocks of collision at these portions. In Table 1, the “number of bubbles that have evolved” is the number of bubbles in the refill 7 when the return operation or the safety operation is repeated 50 times, and is an average value of when the testing is conducted five times (n=5). This value is employed as a parameter for comparing the degrees of shocks.

It will be learned from Table 1 that according to the embodiment, the distance of vertical motion per each time is shortened compared to that of the conventional Kahn knock type, and the number of bubbles that have evolved is decreased. This means that the embodiment prevents the above-mentioned inconvenience caused by a shock in the return operation.

The shock is relaxed presumably based on a mechanism in that upon dividing the vertically moving portion (into two in this embodiment), the final speed of the vertical motion of each time can be decreased compared to when not divided, and therefore the shock of collision can be decreased.

Another mechanism is that upon the motion on the tilted surface in addition to the vertical motion, the reactive force of the spring is divided into a component along the tilted surface, whereby the speed in the direction of the tilted surface (Vt) becomes lower than the speed of the vertical motion. Therefore, the velocity component of Vt in the vertical direction further decreases.

The problem is a shock in the vertical direction which brings down inconvenience in the state of ink in the refill. On the other hand, the shock in the transverse direction due to the speed in a horizontal direction does not cause the problem. However, being limited by a space, it is not allowed to transform all motions into the motion along the tilted surface so as to eliminate the vertically moving portion. Therefore, the problem is ascribable to the arrangement of the vertically moving portions, and the constitution of the present invention was attained by proving the above consideration achieved through a test for confirming the degrees of shocks.

Next, as a second embodiment, described below is an embodiment of the invention of claim 2 concerned to the knock-type writing instrument having a safety mechanism and, further, having a shock-relaxing mechanism. First, general constitution and action of this embodiment will be described and next, characteristic parts of the embodiments will be described.

Provision of the safety mechanism makes the constitution of this embodiment different from the constitution of the above first embodiment and, therefore, makes the arrangement of the cam slightly different correspondingly. This will be described below. Common constituent parts other than the above are denoted by the same reference numerals, and common actions are not described here again.

As shown in FIGS. 1A to 1C, the knock rod 4 is depressed to bring the refill 7 to the writing position protruding beyond the front part of the holder 1 in the same manner as in the first embodiment. This embodiment, however, makes a difference in that an engaging nub 2d of the clip engages with an engaging protuberance 6b of a slide body 6 so that the reactive force of the spring 5 and the partial force of the writing load in the axial direction are supported by a slide body cam 6a that will be described later and that the partial force in the rotational direction is supported by a holder cam 1a that will be described later and that is provided on the inner wall of the holder 1 to thereby hold the write-enabling state.

The embodiment, however, is the same in regard to that the knock rod 4 and the rotor 3 have the knock rod cam 4a and the knock cam 3a which are the tilted cam surfaces corresponding to each other, and the rotor 3 rotates in one direction only by only a predetermined angle each time responsive to the forward knocking operation in the axial direction.

Constituent parts will be described hereinbelow.

In this embodiment, the inner cylinder 2 shown in FIGS. 1A to 1C and 2 is constituted integrally with a clip 2a. On the inner wall surface of the inner cylinder, there are arranged grooves 2c for stopping the turn of the knock rod 4 and an inner cylinder cam 2b for positioning the refill 7. The shape of the inner cylinder cam 2b will be described later in detail. Further, an engaging nub 2d for engagement with the slide body 6 is formed at an end of the clip 2a.

The knock rod 4 shown in FIGS. 1A to 1C and 4, and the rotor 3 shown in FIGS. 1A to 1C and 5 have the constitutions and actions that are the same as those of the first embodiment.

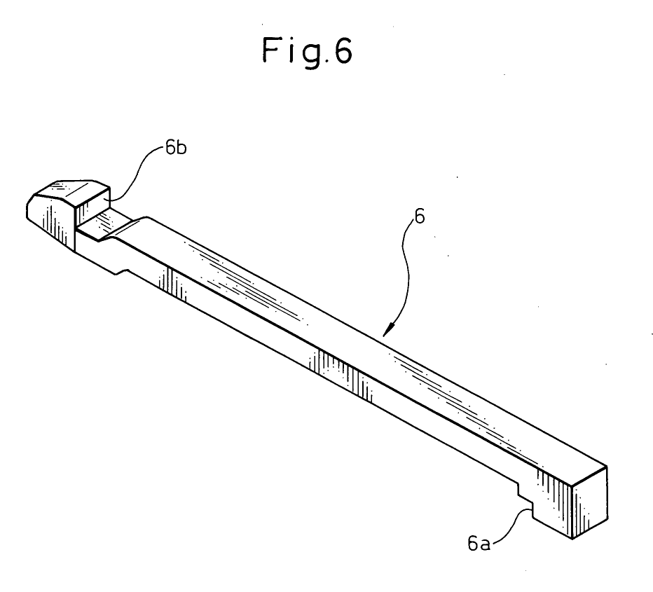

The slide body 6 shown in FIGS. 1A to 1C, 3A, 3B and 6 is a rod-like member which is provided in a cut-away portion (cross section A-A) formed in the holder 1 on the inside of the clip 2a as shown in FIGS. 1A to 1C and 3A and 3B, and is exposed to the outer side of the holder 1. The rear end portion of the slide body 6 is fitted in a groove formed in the inner surface of the inner cylinder 2 so as to slide therein (cross section B-B).

The slide body 6 has a slide body cam 6a at a rear end on the inside thereof and with which will come in contact the cam protuberance 3b of the rotor 3, and, further, has an engaging protuberance 6b at an end on the outer side thereof and with which will come in engagement the engaging nub 2d of the clip 2a.

Next, the action of the thus constituted knock-type writing instrument will be described.

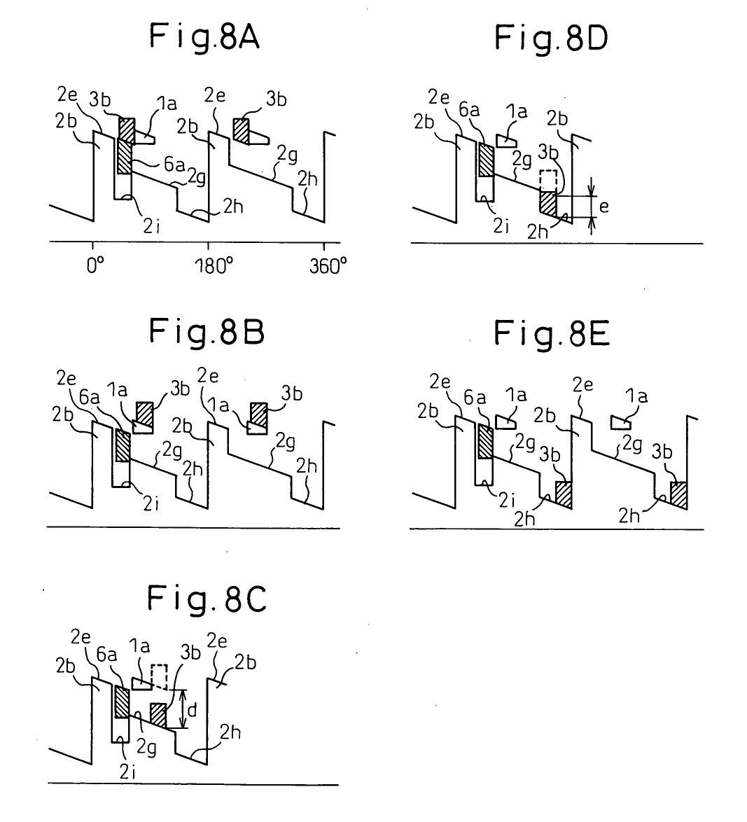

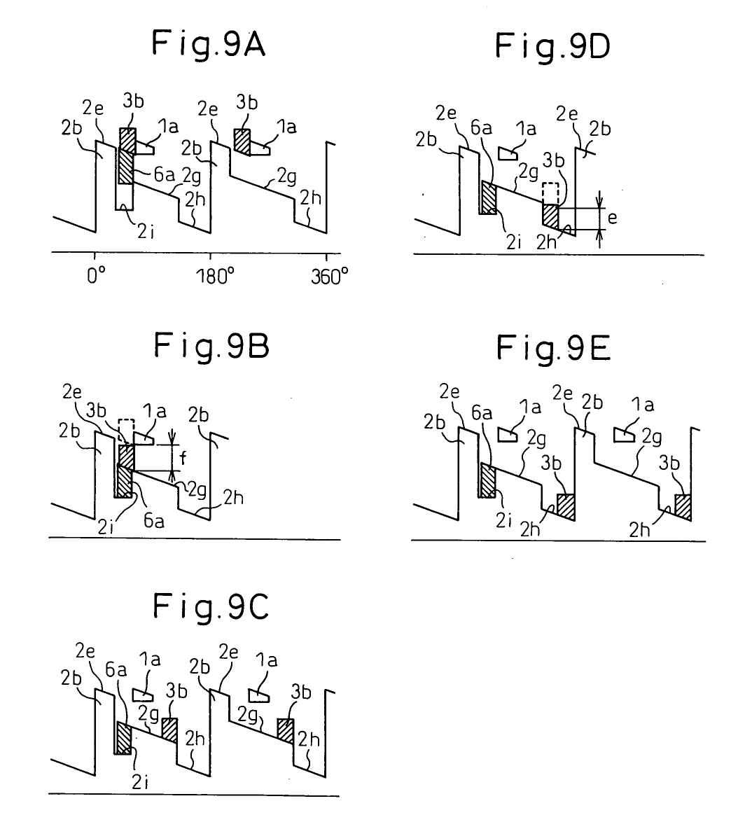

If the knock rod 4 is depressed from a state where the pen point has been into the holder 1, and then released, the cam protuberance 3b of the rotor 3 undergoes a rotational motion along the inner cylinder cam 2b. The cam protuberance 3b of the rotor 3 comes in contact with the vertical wall of the holder cam 1a and stops rotating. At a position where the rotation stops, the pen point at the end of the refill 7 is brought to a writing position shown in FIGS. 8A and 9A.

At this moment, further, the cam protuberance 3b of the rotor 3 is on the slide body cam 6a moving from the inner cylinder cam 2b. The load exerted on the rotor 3 in the axial direction thereof, i.e., the load due to the reacting force of the spring 5 and the writing, is transmitted from the cam protuberance 3b of the rotor 3 to the slide body cam 6a, and is supported by a portion where the engaging protuberance 6b of the slide body 6 is in engagement with the engaging nub 2d of the clip 2a.

Next, constitutions of the cams which are characteristic parts of the embodiment and the motion of cam protuberance 3b of the rotor 3 in the return operation after the knock is released, will be described with reference to FIGS. 8A to 8E.

FIGS. 8A to 8E are schematic views illustrating positional relationships among the cam protuberance 3b of the rotor 3, inner cylinder cam 2b, holder cam 1a and slide body cam 6a, and show the arrangement of the cam protuberance 3b of the rotor 3, holder cam 1a and slide body cam 6a with respect to the development of the inner cylinder cam 2b formed on the inner surface of the inner cylinder 2.

Unlike that of FIGS. 7A to 7E, the inner cylinder cam 2b of this embodiment has a groove 2i for slide body cam of a safety mechanism, has a wall of the groove 2i that becomes lower in the direction of rotation, and is provided with an opening relative to the holder cam 1a on the upper side. The upper end of the above wall is connected to a front half wall 2g of the second tilted surface. The action of this portion will be described later with reference to the safety operation.

FIGS. 8A to 8E illustrate the motions of the cam protuberance 3b of the rotor 3 in the return operation. FIG. 8A shows a state where the pen point is protruded for writing, wherein the cam protuberance 3b is fixed being pushed, in the axial direction, onto the tilted surface of the slide body cam 6a arranged at a position continuous to the first tilted surface of the inner cylinder cam 2b and being pushed, in the rotational direction, onto the vertical wall of the holder cam 1a due to the reactive force of the spring 5.

If the knock rod 4 is depressed in this state, the cam protuberance 3b of the rotor 3 moves upward in the drawing, arrives at a position exceeding the vertical wall of the holder cam 1a and is, thereafter, no longer limited by the vertical wall of the holder cam 1a. Due to the reactive force of the spring 5 and the action of the above tilted cam surface for rotation, therefore, the cam protuberance 3b of the rotor 3 rotates toward the right and is pushed onto the tilted surface of the holder cam 1a as shown in FIG. 8B.

When pressure is released, the cam protuberance 3b further rotates and arrives at a position shown in FIG. 8C passing through a first vertical motion. At this moment, the tilted surface of the cam protuberance 3b comes into collision with the front half portion of the second tilted surface (hereinafter referred to as “front half tilted surface”) 2g of the inner cylinder cam 2b, and a shock is transmitted to the refill 7.

Further, the cam protuberance 3b rotates sliding on the front half tilted surface 2g of the inner cylinder cam 2b, and arrives at a position shown in FIG. 8D passing through a second vertical motion. At this moment, the tilted surface of the cam protuberance 3b collides again with the rear half portion of the second tilted surface (hereinafter referred to as “rear half tilted surface”) 2h of the inner cylinder cam 2b, and a shock is transmitted to the refill 7.

Thereafter, the cam protuberance 3b rotates sliding on the rear half tilted surface 2h of the inner cylinder cam 2b, and halts coming in contact with the vertical wall of the inner cylinder cam 2b, i.e., arrives at a pen point-holding position shown in FIG. 8E.

In this embodiment, too, like in the first embodiment, a step in the axial direction is provided between the front half and the rear half of the second tilted surface of the inner cylinder cam 2b so as to shorten the distance of vertical motion of the cam protuberance 3b per one time and, therefore, to decrease the shock imparted to the refill at the time of collision. The mechanism of relaxing the shock is the same as the one described above.

Table 1 shows the distances d, e of vertical motions at two places in the above constitution, and the numbers of bubbles evolved that serve as parameters of degrees of shocks of collision.

Further described below with reference to FIGS. 9A to 9E are the constitutions of the cams which are characteristic parts of the embodiment and motions of the cam protuberance 3b of the rotor 3 in the safety operation.

Like FIGS. 8A to 8E, FIGS. 9A to 9E illustrate the motions of the cam protuberance 3b of the rotor 3 in the safety operation. FIG. 9A shows a state where the pen point is protruded in the state of writing, wherein the cam protuberance 3b is fixed being pushed, in the axial direction, onto the tilted surface of the slide body cam 6a and being pushed, in the rotational direction, onto the vertical wall of the holder cam 1a due to the reactive force of the spring 5.

If the clip 2a is lifted up in the state shown in FIG. 9A, the engaging protuberance 6b of the slide body 6 is disengaged from the engaging nub 2d at the end of the clip 2a as described above. The refill 7, rotor 3 and slide body 6 move backward.

Referring to FIG. 9B, a first vertical motion is executed at a moment when the slide body 6 reaches the retreated limit together with the cam protuberance 3b, and a shock imparted to the cam protuberance 3b is transmitted to the refill 7. At the retreated limit at the same time, the cam protuberance 3b of the rotor 3 is no longer limited by the vertical wall of the holder cam 1a and is, therefore, allowed to rotate. Therefore, the cam protuberance 3b rotates rightward along the front half tilted surface 2g of the second tilted surface of the inner cylinder cam 2b, and assumes a state of FIG. 9C.

Due to the reactive force of the spring 5, the cam protuberance 3b undergoes a second vertical motion as shown in FIG. 9D, comes in collision with the rear half tilted surface 2h of the second tilted surface of the inner cylinder cam 2b, rotates along the rear half tilted surface 2h, and arrives at the holding position shown in FIG. 9E. After the safety mechanism has worked, the slide body 6 is pushed by the end of a turn stop 4b of the knock rod 4 responsive to the first knocking operation, and returns back to the predetermined position shown in FIG. 9A.

Upon dividing the second tilted surface of the inner cylinder cam 2b by a step into the front half and the rear half, the vertical motion that was so far effected one time is effected two times stepwise making it possible to greatly decrease the shock of collision per one time in the safety operation, too. Table 1 shows the distances f, e of vertical motions at the above two places and the numbers of bubbles evolved representing the degrees of shocks due to the collisions.

According to Table 1, the numbers of bubbles evolved in the embodiments are decreasing as compared to the prior art either in the case of return operation or in the case of safety operation, and the effect for relaxing shocks is obvious.

Next, another embodiment of the invention of claim 2 will be described as a third embodiment.

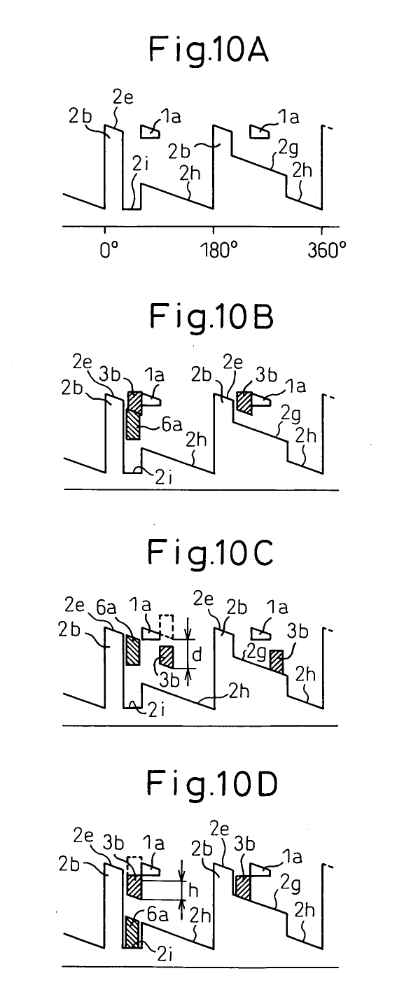

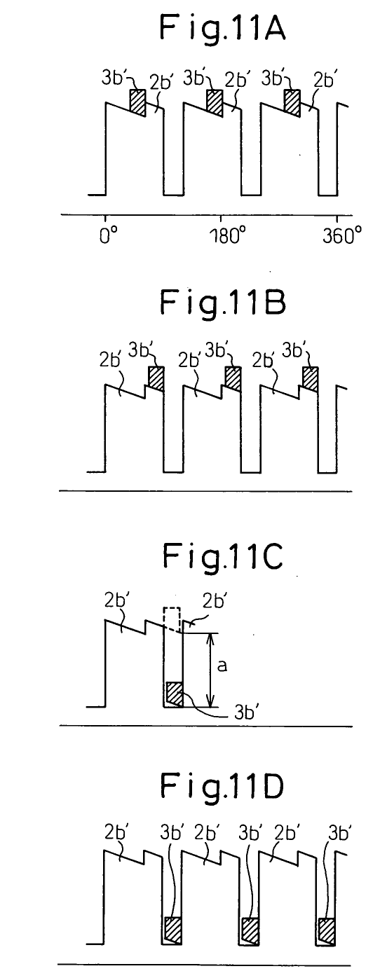

First, the constitution will be described with reference to FIGS. 10A to 10D.

According to this embodiment as shown in FIG. 10A, of the two second tilted surfaces of the inner cylinder cams 2b at two places, only one second tilted surface is provided with a step to divide it into the front half and the rear half. The second tilted surface of the other place (on the side to where the groove for slide body 6 is neighboring) is provided with the rear half tilted surface provided for the other second tilted surface extending up to the front half portion.

The above constitution is to widen the gap between the holder cam la and the tilted surface 2h of the inner cylinder cam 2b neighboring the groove for slide body cam 6a so that the cam protuberance 3b is allowed to smoothly pass through the gap in the safety operation.

By employing the above constitution, the tilted surface of the inner cylinder cam 2b of the portion of the slide body cam 6a does not come into collision with the cam protuberance 3b in the first vertical motion (distance d) in the return operation as shown in FIG. 10C. The collision of the cam protuberance 3b occurs only with the tilted surface of the other inner cylinder cam 2b. In the second vertical motion (distance e), on the other hand, the collision of the cam protuberance 3b occurs with the tilted surfaces of the inner cylinder cams 2b at two places.

In the safety operation, further, the tilted surface of the inner cylinder cam 2b of the portion of the slide body cam 6a does not collide with the cam protuberance 3b in the first vertical motion (distance h) as shown in FIG. 10D. Collision of the cam protuberance 3b occurs only with the tilted surface of the other inner cylinder cam 2b. In the second vertical motion (distance e), on the other hand, the collision of the cam protuberance 3b occurs with the tilted surfaces of the inner cylinder cams 2b at two places.

Table 1 shows the distances of vertical motions of the case of the above constitution and the numbers of bubbles evolved representing the degrees of shocks by the collision. It will be learned that the shock is relaxed in this embodiment, too.

In the above constitution, the surfaces where the cam protuberance 3b and the slide body cam 6a are contacted together are further depressed to be lower than the first tilted surface of the inner cylinder cam 2b at the time of writing shown in FIG. 10B. This constitution is to reliably receive the partial force of the reactive force of the spring 5 exerted on the cam protuberance 3b in the rotational direction by the vertical wall of the holder cam 1a, by providing a predetermined play at a portion where the clip-engaging nub 2d engages with the engaging protuberance 6b of the slide body 6 and permitting the contact surface to be depressed down to the above position. In the safety operation, the clip 2a is lifted up to disengage the engaging protuberance 6b of the slide body 6 from the engaging nub 2d at the end of the clip 2a at a position where there is no play. Therefore, the distance h of the first vertical motion of FIG. 10D is equal to the distance f of the first vertical motion of FIG. 9B of the second embodiment.

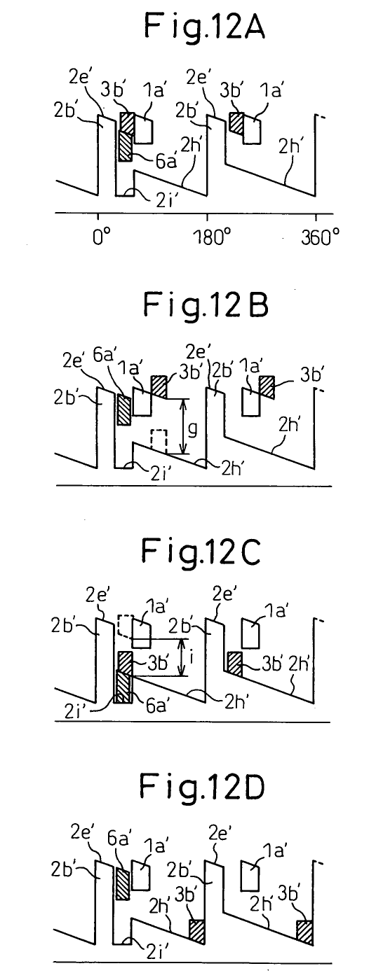

FIGS. 12A to 12D illustrate an example (trial model) in comparison with the embodiments of the invention. The comparative example is concerned with a writing instrument having a safety function but without having the above shock-relaxing measure. No step is formed on the second tilted surface of an inner cylinder cam 2b′, and one time of vertical motion takes place either in the return operation or the safety operation. Table 1 shows distances g, i thereof and the numbers of bubbles evolved.

In the above constitution, the vertical motion occurs at one place and it is attempted to relax the shock by the deceleration at the portion of a tilted surface 2h′ of the inner cylinder cam 2b′. However, the vertical motion of one time (distance g in the return operation, distance i in the safety operation) produces a large shock of collision, and the effect for relaxing the shock is not sufficient.

As compared to the constitution of the above comparative example, the second and third embodiments (FIG. 8A to FIG. 10D) form a step in the axial direction on the second tilted surface of the inner cylinder cam 2b to divide it into the front half and the rear half. Namely, in the drawings, the height of the front half tilted surface is increased, the vertical wall of the holder cam 1a is shortened, and a gap is maintained through which the cam protuberance 3b passes in the safety operation.

TABLE 1

| | | First | Second | Number of |
|---|---|---|---|---|
| | | vertical | vertical | bubbles |
| Type | | motion (mm) | motion (mm) | evolved |
| Conventional Kahn's knock | | a = 6 | | 33 |
| type | | | | |
| First embodiment | | b = 3 | c = 1.5 | 1.6 |
| (without safety) | | | | |
| Second embodiment | In return | d = 3 | e = 1.5 | 1.6 |
| (with safety) | operation | | | |
| | In safety | f = 2 | e = 1.5 | 1.0 |
| | operation | | | |
| Third embodiment | In return | d = 3 | e = 1.5 | 1.6 |
| (with safety) | operation | | | |
| | In safety | h = 2 | e = 1.5 | 1.0 |
| | operation | | | |
| Comparative | In return | g = 4.5 | | 3.3 |
| example | operation | | | |
| (with safety) | In safety | i = 3 | | 1.2 |
| | operation | | | |

According to the embodiments 1 to 3 as shown in Table 1, the distance of one time of vertical motion of the cam protuberance 3b is shortened as compared to that of the conventional constitution, and the shock of collision on the tilted cam surface is relaxed correspondingly. Comparison of the numbers of bubbles evolved with those of the conventional constitution shows that the shocks are relaxed in the embodiments 1 to 3.

As described above, the present invention makes it possible to relax the shocks at the time of return operation and safety operation and to provide a knock-type writing instrument that does not permit the occurrence of ink leakage or blurred writing by using a decreased number of parts and even by using an aqueous ink or a gel ink.

### LIST OF REFERENCE NUMERALS

1—holder

1a—holder cam

2—inner cylinder

2a—clip

2b—inner cylinder cam

2c—grooves

2d—engaging nub

2e—first tilted surface

2f—second tilted surface

2g—front half tilted surface

2h—rear half tilted surface

2i—groove for slide body cam

3—rotor

3a—knock cam

3b—cam protuberance

4—knock rod

4a—knock rod cam

4b—turn stop

5—spring

6—slide body

6a—slide body cam

6b—engaging protuberance

7—refill

1. A knock-type writing instrument comprising a refill having a writing portion at a front end thereof, a spring for urging the refill backward, and a knock rod that is arranged at the back of said refill and is linked to said refill and protrudes beyond the rear end of a holder, wherein upon depressing said knock rod, the refill is brought to a writing position protruding beyond the front end of said holder; and wherein,
a rotor is provided between said knock rod and the refill to support the refill, the knock rod and said rotor have tilted cam surfaces for rotation corresponding to each other, and the rotor rotates in only one direction by only a predetermined angle each time due to the reactive force of said spring and responsive to the knocking operation forward and backward in the axial direction;
when the knocking operation is effected in a state where the refill has been drawn back into the holder, a tilted cam surface for positioning formed on the side surface of a cylindrical portion of the rotor comes in contact with a first tilted surface of the cam formed in an inner cylinder corresponding thereto, and a vertical surface of the cam for positioning of the rotor comes in contact with a vertical wall of a cam formed in the inner cylinder and maintains the refill at said writing position being supported by the load in the axial direction and by the rotational force;
when the knocking operation is effected in a state where the refill is at the writing position, said tilted cam surface for positioning of the rotor comes in contact with a second tilted surface of the cam formed in the inner cylinder continuing to the vertical wall of said cam and, further, rotates upon coming in contact with a third tilted surface of the cam formed in the inner cylinder, and moves to a retreated limit position to maintain the refill at the holding position;
wherein the third tilted surface of said cam formed in the inner cylinder has a step in the axial direction.

2. A knock-type writing instrument comprising a refill having a writing portion at a front end thereof, a spring for urging the refill backward, and a knock rod that is arranged at the back of said refill and is linked to said refill and protrudes beyond the rear end of a holder, wherein upon depressing said knock rod, the refill is brought to a writing position protruding beyond the front end of said holder and an engaging nub of a clip is engaged with an engaging protuberance of a slide body to maintain said writing position; and wherein
a rotor is provided between said knock rod and the refill to support the refill, the knock rod and said rotor have tilted cam surfaces for rotation corresponding to each other, and the rotor rotates in only one direction by only a predetermined angle each time due to the reactive force of said spring and responsive to the knocking operation forward and backward in the axial direction;
when the knocking operation is effected in a state where the refill has been drawn back into the holder, a tilted cam surface for positioning formed on the side surface of a cylindrical portion of the rotor comes in contact with a first tilted surface of the cam formed in an inner cylinder corresponding thereto and with a tilted cam surface formed on the slide body successively, and a vertical surface of the cam for positioning of the rotor comes in contact with a vertical wall of a cam formed in the holder and maintains the refill at a writing position being supported by the load in the axial direction and by the rotational force;
when the knocking operation is effected in a state where the refill is at the writing position, said tilted cam surface for positioning of the rotor comes in contact with a tilted cam surface formed in the holder and, further, rotates upon coming in contact with a second tilted surface of the cam formed in the inner cylinder, and moves to a retreated limit position to maintain the refill at the holding position;
the slide body that can move in the lengthwise direction has an inward protuberance in a cut-away portion of the holder and when the refill is at the writing position, said inward protuberance is brought into engagement with a rear end of the cam for positioning of the rotor, and an engaging protuberance formed on the slide body engages with an engaging step formed in a clip body to maintain the refill at the writing position;
when the engagement is released between said engaging protuberance of the slide body and said engaging step of the clip body, the refill is returned by the spring back to the retreated position together with the slide body, and the positioning cam of the rotor moves to the retreated limit position passing through a gap formed at the back of the tilted cam surface of the holder to maintain the refill at the holding position;
wherein the second tilted surface of said cam formed in the inner cylinder has a step in the axial direction.
